(19) United States
(12) Patent Application Publication
(10) Pub. No.: US 2025/0272973 A1
(43) Pub. Date: Aug. 28, 2025

(54) SYSTEM AND METHOD FOR AN AGRICULTURAL VEHICLE

(71) Applicants: CNH INDUSTRIAL BELGIUM N.V., Zedelgem (BE); CNH Industrial Brasil Ltda., Nova Lima (BR)

(72) Inventors: Bart M.A. Missotten, Zedelgem (BE); Yuanyuan Li, Zedelgem (BE); Andre Satoshi Seki, Nova Lima (BR); Rafael Gazeta de Oliveira, Nova Lima (BR); Joao Augusto Marcolin Lucca, Nova Lima (BR); Marcos Ikeguchi Ohira, Nova Lima (BR); Sidney Roberto Dias de Carvalho, Florianópolis (BR); Feres Azevedo Salem, Florianópolis (BR); Arthur Weschenfelder d’Avila, Florianópolis (BR)

(21) Appl. No.: 19/062,733

(22) Filed: Feb. 25, 2025

(30) Foreign Application Priority Data
Feb. 26, 2024 (BR) 10 2024 003768 5

(51) Int. Cl. G06V 20/10; A01D 45/10

(52) U.S. Cl. CPC G06V 20/188; A01D 45/10

(57) ABSTRACT

A system for an agricultural vehicle includes a topper assembly including a cutting disk configured to severe an upper portion of a crop. A sensor system can include a first sensor having a first focal axis and a second sensor having a second focal axis. The second focal axis can intersect the first focal axis. A computing system can be configured to receive an input related to a defined offset, receive the data from the sensor system, determine an intermediate position of the cutting disk based on data from the second sensor, and position the cutting disk at a cutting position along the crop based on data from the first sensor. The cutting position can be the defined offset below the target.

### FIELD OF THE INVENTION

The present disclosure relates generally to agricultural vehicles, such as sugarcane vehicles, and, more particularly, to systems and methods for a topper assembly of the agricultural vehicle.

### BACKGROUND OF THE INVENTION

In some cases, agricultural vehicles include an assembly of processing components for processing harvested material. For instance, within a sugarcane vehicle, a topper assembly can remove an upper portion of the sugar cane crop. The remaining sugarcane stalks may then be conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

During the operation of the vehicle, the amount of harvested material that may be delivered to the external storage device is at least partially based on the amount of stalk that is severed by the topper assembly. Accordingly, systems and methods for monitoring the topper assembly would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a system for an agricultural vehicle. The system includes a topper assembly including a cutting disk configured to severe an upper portion of a crop. A sensor system includes a first sensor having a first focal axis and configured to capture data associated with the crop and a second sensor having a second focal axis and configured to capture data associated with the crop, the first focal axis offset from the second focal axis. A computing system includes one or more processors and one or more non-transitory computer-readable media that collectively store instructions that, when executed by the one or more processors, configure the computing system to perform operations. The operations include receiving an input related to a defined offset, detecting an object forward of the topper assembly based at least partially on the data from the second sensor, determining a target of the crop based at least partially on the data from the second sensor, and positioning the cutting disk at a cutting position along the crop, wherein the cutting position is the defined offset below the target.

In some aspects, the present subject matter is directed to a computer-implemented method for agricultural harvesting. The computer-implemented method includes receiving, from an input device, an input related to a defined offset. The method further includes determining, with a computing system, a target of a crop based at least partially on data from a first sensor. The method also includes receiving, from a second sensor, data related to an object proximate to a vehicle. Lastly, the method includes positioning a cutting disk at a cutting position along the crop, wherein the cutting position is the defined offset below the target.

In some aspects, the present subject matter is directed to a system for an agricultural vehicle. The system includes a topper assembly including a cutting disk configured to severe an upper portion of a crop. A sensor system includes a first sensor having a first focal axis and a second sensor having a second focal axis, the second focal axis intersecting the first focal axis. A computing system including one or more processors and one or more non-transitory computer-readable media that collectively store instructions that, when executed by the one or more processors, configure the computing system to receive an input related to a defined offset, receive data from the sensor system, determine an intermediate position of the cutting disk based on data from the second sensor, determine a target on the crop based on data from the first sensor, and position the cutting disk at a cutting position along the crop based on data from the first sensor, wherein the cutting position is the defined offset below the target.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural vehicle in accordance with aspects of the present subject matter;

FIG. 2 illustrates a side view of a portion of the vehicle having a topper assembly within a field in accordance with aspects of the present subject matter;

FIG. 3 illustrates a schematic view of a system for a harvesting operation in accordance with aspects of the present subject matter;

FIG. 4 illustrates a side view of the topper assembly in accordance with aspects of the present subject matter;

FIG. 5 illustrates a side view of the agricultural vehicle in accordance with aspects of the present subject matter;

FIG. 6 illustrates a side view of the agricultural vehicle in accordance with aspects of the present subject matter;

FIG. 7 illustrates a side view of the agricultural vehicle in accordance with aspects of the present subject matter; and

FIG. 8 illustrates a flow diagram of a method for a harvesting operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a fluid circuit. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for agricultural vehicles. The system can include a topper assembly that can remove an upper portion of the sugar cane crop. The remaining sugarcane stalks may then be conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

A sensor system can be operably coupled with the topper assembly and can include a first sensor having a first focal axis and a second sensor having a second focal axis. In some instances, the second focal axis can intersect the first focal axis.

A computing system can including one or more processors and one or more non-transitory computer-readable media that collectively store instructions that, when executed by the one or more processors, can configure the computing system to receive an input related to a defined offset, receive data from the sensor system, determine an intermediate position of the cutting disk based on data from the second sensor, and position the cutting disk at a cutting position along the crop based on data from the first sensor. In some examples, the cutting position is the defined offset below the target.

In various cases, the systems and methods described herein may lead to a reduction of harvest losses when removing an upper portion of the sugar cane crop, or any other crop as the system can be a proactive and non-reactive system. Moreover, the system provided herein may allow for the possibility of cutting the upper portion of the sugar cane crop on undulating terrain and on fallen crops, among other benefits of the disclosed system.

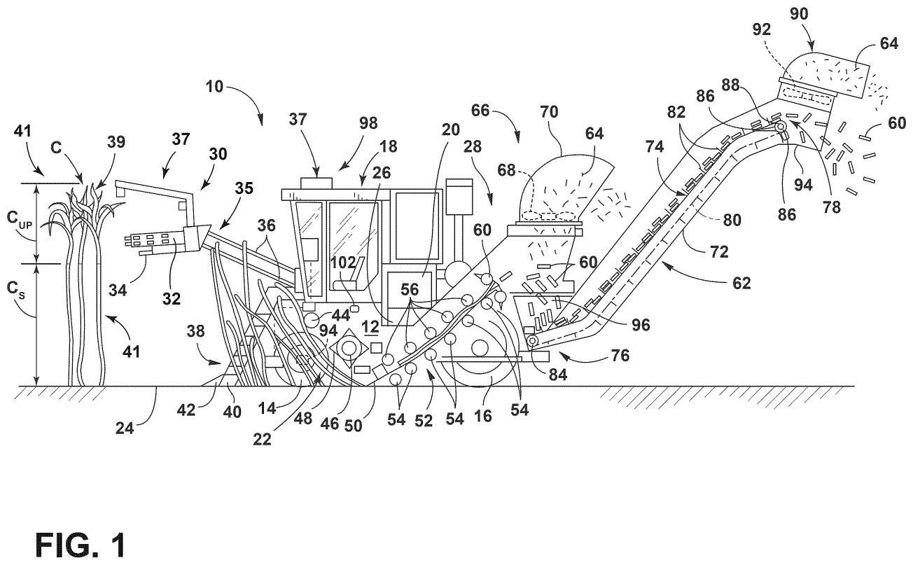

Referring now to the drawings, FIG. 1 illustrates a side view of an agricultural vehicle 10 in accordance with aspects of the present subject matter. As shown, the vehicle 10 is configured as a sugarcane vehicle. The sugarcane may include an upper portion Cᵤₚ that includes one or more leaves and a stalk Cₛ below the upper portion Cᵤₚ. It will be appreciated that, in other examples, the vehicle 10 may correspond to any other suitable agricultural vehicle capable of harvesting any other crop without departing from the teachings provided herein.

As shown in FIG. 1, the vehicle 10 can include a frame 12, a pair of front wheels 14, a pair of rear wheels 16, and an operator's cab 18. The vehicle 10 may also include a power source 20 (e.g., an engine mounted on the frame 12) that powers one or both pairs of wheels 14, 16 via a driveline assembly 22 (e.g., a transmission) to traverse a field 24. Alternatively, the vehicle 10 may be a track-driven vehicle and, thus, may include tracks driven by the power source 20 as opposed to the illustrated wheels 14, 16. The power source 20 may also drive a hydraulic fluid pump 26 to power various components of the vehicle 10, including the driveline assembly 22.

The vehicle 10 may also include a harvested material processing system 28 incorporating various components, assemblies, and/or sub-assemblies of the vehicle 10 for cutting, processing, cleaning, and discharging sugarcane as the stalk Cₛ is harvested from an agricultural field 24. For instance, the harvested material processing system 28 may include a topper assembly 30 positioned at the front-end portion of the vehicle 10 to intercept sugarcane as the vehicle 10 is moved in a forward direction. As shown, the topper assembly 30 may include a gathering disk 32 and/or a cutting disk 34. The gathering disk 32 may be configured to gather the sugarcane stalks Cₛ so that the cutting disk 34 may be used to cut off an upper portion Cᵤₚ of each stalk Cₛ. The height of the topper assembly 30 may be adjustable, which may be raised and lowered by an adjustment assembly 35 that may be hydraulically powered by the hydraulic fluid pump 26 and/or through any other manner (e.g., electrically powered, mechanically powered, manually adjusted, etc.). In some examples, the adjustment assembly 35 may include a pair of arms 36 for adjusting a height of the topper assembly 30. Additionally or alternatively, the adjustment assembly 35 may allow for the arms 36 and the topper assembly 30 to rotate relative to the frame 12 of the vehicle 10 and/or the topper assembly 30 to rotate relative to the arms 36.

The harvested material processing system 28 may also include a sensor system 37 that is configured to capture data associated with the crop C. Based on the data, the adjustment assembly 35 may alter the height of the topper assembly 30. For example, in some cases, the sensor system 37 may capture data indicative of a target 39 associated with the crop C and/or an object 41 proximate to the vehicle 10. Based on the position of the target 39, the adjustment assembly 35 may alter the height of the topper assembly 30 so that a generally common upper portion Cᵤₚ height may be removed from each of the crops C harvested by the vehicle 10.

The harvested material processing system 28 may further include a harvested material divider 38. In general, the harvested material divider 38 may include one or more spiral feed rollers 40. Each feed roller 40 may include a ground shoe 42 at its lower end portion to assist the harvested material divider 38 in gathering the sugarcane stalks Cₛ for harvesting.

Moreover, as shown in FIG. 1, the harvested material processing system 28 may include a knock-down roller 44 positioned near the front wheels 14 and a fin roller 46 positioned behind the knock-down roller 44. As the knock-down roller 44 is rotated, the sugarcane stalks Cₛ being harvested are knocked down while the harvested material divider 38 gathers the stalks Cₛ from agricultural field 24. Further, as shown in FIG. 1, the fin roller 46 may include a plurality of intermittently mounted fins 48 that assist in forcing the sugarcane stalks Cₛ downward. As the fin roller 46 is rotated during the harvest, the sugarcane stalks Cₛ that have been knocked down by the knock-down roller 44 are separated and further knocked down by the fin roller 46 as the vehicle 10 continues to be moved in the forward direction relative to the field 24.

Referring still to FIG. 1, the harvested material processing system 28 of the vehicle 10 may also include a base cutter assembly 50 positioned behind the fin roller 46. The base cutter assembly 50 may include blades for severing the sugarcane stalks Cₛ as the sugarcane is being harvested. The blades, which may be located on a periphery section of the base cutter assembly 50, may be rotated by a hydraulic circuit. Additionally, in several examples, the blades may be angled downward to sever the base of the sugarcane as the cane is knocked down by the fin roller 46.

Moreover, the harvested material processing system 28 may include a feed roller assembly 52 located downstream of the base cutter assembly 50 for moving the severed stalks Cₛ of sugarcane from base cutter assembly 50 along the processing path of the harvested material processing system 28. As shown in FIG. 1, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris (e.g., rocks, dirt, and/or the like) may be allowed to fall through bottom rollers 54 onto the field 24.

In addition, the harvested material processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks Cₛ into pieces or “billets” 60, which may be, for example, six (6) inches long. The billets 60 may then be propelled towards an elevator assembly 62 of the harvested material processing system 28 for delivery to an external receiver or storage device.

The pieces of debris 64 (e.g., dust, dirt, leaves, etc.) separated from the sugarcane billets 60 may be expelled from the vehicle 10 through a primary extractor 66 of the harvested material processing system 28, which may be located downstream of the chopper assembly 58 and may be oriented to direct the debris 64 outwardly from the vehicle 10. Additionally, an extractor fan 68 may be mounted within an extractor housing 70 of the primary extractor 66 for generating a suction force or vacuum sufficient to force the debris 64 through the primary extractor 66. The separated or cleaned billets 60, which may be heavier than the debris 64 expelled through the extractor 66, may then fall downward to the elevator assembly 62.

As shown in FIG. 1, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60 on the elevator 74 as the sugarcane billets 60 are elevated along a top span of the elevator 74 defined between its proximal and distal end portions 76, 78. Additionally, the elevator 74 may include lower and upper sprockets 84, 86 positioned at its proximal and distal end portions 76, 78, respectively. As shown in FIG. 1, an elevator motor 88 may be coupled to one of the sprockets (e.g., the upper sprocket 86) for driving the chain 80, thereby allowing the chain 80 and the paddles 82 to travel in a loop between the proximal and distal end portions 76, 78 of the elevator 74.

Moreover, in some examples, pieces of debris 64 (e.g., dust, dirt, leaves, etc.) separated from the elevated sugarcane billets 60 may be expelled from the vehicle 10 through a secondary extractor 90 of the harvested material processing system 28 coupled to the rear end portion of the elevator housing 72. For example, the debris 64 expelled by the secondary extractor 90 may be debris 64 remaining after the billets 60 are cleaned and debris 64 expelled by the primary extractor 66. As shown in FIG. 1, the secondary extractor 90 may be located adjacent to the distal end portion 78 of the elevator 74 and may be oriented to direct the debris 64 outwardly from the vehicle 10. Additionally, an extractor fan 92 may be mounted at the base of the secondary extractor 90 to generate a suction force or vacuum sufficient to force the debris 64 through the secondary extractor 90. The separated, cleaned billets 60, heavier than the debris 64 expelled through the primary extractor 66, may then fall from the distal end portion 78 of the elevator 74. In some instances, the billets 60 may fall downwardly into an elevator discharge opening 94 defined by the elevator assembly 62 into an external storage device, such as a sugarcane billet cart.

During operation, the vehicle 10 traverses the agricultural field 24 for harvesting sugarcane and receives data related to one or more targets 39 associated with the approaching crop C. Based at least partially on the one or more targets 39 (and/or any other input), the height of the topper assembly 30 is adjusted via the adjustment assembly 35. With the topper assembly 30 positioned in a defined position, the gathering disk 32 on the topper assembly 30 may function to gather the sugarcane stalks Cₛ as the vehicle 10 proceeds across the field 24, while the cutting disk 34 severs the upper portions Cᵤₚ of the sugarcane crop C for disposal. As the stalks Cₛ enter the harvested material divider 38, the ground shoes 42 may set an operating width to determine the quantity of sugarcane entering a throat of the vehicle 10. The spiral feed rollers 40 then gather the stalks Cₛ into the throat to allow the knock-down roller 44 to bend the stalks Cₛ downwardly in conjunction with the action of the fin roller 46. Once the stalks Cₛ are angled downward as shown in FIG. 1, the base cutter assembly 50 may then sever the base of the stalks Cₛ from field 24. The severed stalks Cₛ are then, by the movement of the vehicle 10, directed to the feed roller assembly 52.

The severed sugarcane stalks Cₛ are conveyed rearwardly by the bottom and top rollers 54, 56, which compresses the stalks Cₛ, making them more uniform, and shakes loose debris 64 to pass through the bottom rollers 54 to the field 24. At the downstream end portion of the feed roller assembly 52, the chopper assembly 58 cuts or chops the compressed sugarcane stalks Cₛ into pieces or billets 60 (e.g., 6-inch cane sections). The processed harvested material discharged from the chopper assembly 58 is then directed as a stream of billets 60 and debris 64 into the primary extractor 66. The airborne debris 64 (e.g., dust, dirt, leaves, etc.) separated from the billets 60 is then extracted through the primary extractor 66 using suction created by the extractor fan 68. The separated/cleaned billets 60 may then be directed to an elevator hopper 96 into the elevator assembly 62 and travel upwardly via the elevator 74 from its proximal end portion 76 to its distal end portion 78. Once the billets 60 reach the distal end portion 78 of the elevator 74, the billets 60 fall through the elevator discharge opening 94 to an external storage device. If provided, the secondary extractor 90 (with the aid of the extractor fan 92) blows out trash/debris 64 from the vehicle 10, similar to the primary extractor 66.

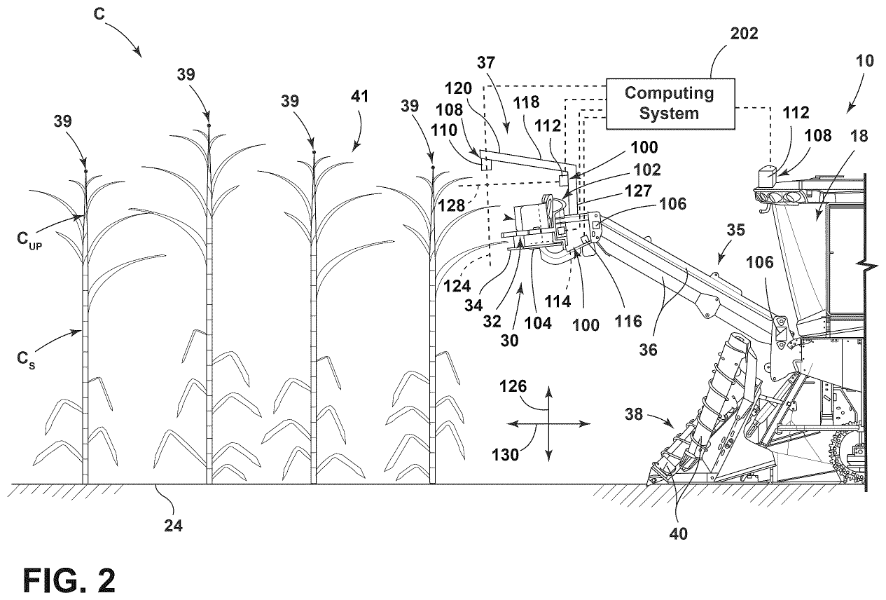

Referring now to FIG. 2, a side view of a portion of the vehicle 10 within a field 24 is illustrated in accordance with aspects of the present subject matter. As shown in FIG. 2, the topper assembly 30 may include a frame 100 and a deflector 102. The topper assembly 30 may further include a pair of gathering disks 32 and/or a cutting disk 34 positioned on an opposing side of the deflector 102 from the cab 18 of the vehicle 10. The gathering disk 32 may be configured to gather the sugarcane stalks Cₛ so that the cutting disk 34 may be used to cut off an upper portion Cᵤₚ of each stalk Cₛ. As illustrated, each of the pair of gathering disks 32 and/or a cutting disk 34 may be operably coupled with an actuation device 104, such as a motor, which may be hydraulically powered, pneumatically powered, electrically powered, and/or powered through any other source. Each pair of gathering disks 32 and/or a cutting disk 34 may be respectively coupled with independent actuation devices 104. Alternatively, any pair of gathering disks 32 and/or a cutting disk 34 may share a common actuation device 104.

The topper assembly 30 may be operably coupled with the remaining portions of the vehicle 10, such as the frame 12, through an adjustment assembly 35. The adjustment assembly 35 may include one or more arms 36 and an actuation system 106. The actuation system 106 may be hydraulically powered, pneumatically powered, electrically powered, and/or powered through any other source for moving the topper assembly 30 between a plurality of positions relative to the field 24.

In some examples, the sensor system 37 may be associated with the topper assembly 30. For example, the sensor system 37 may include one or more sensors 108 that may be operably coupled with the topper assembly 30, the adjustment assembly 35, and/or any other component of the vehicle 10 (e.g., the cab 18 of the vehicle 10). For instance, the sensor system 37 can include first and second sensors 110, 112 that are configured to capture data related to the field 24 and/or crops C within the field 24, an operational sensor 114, an adjustment assembly sensor 116, and/or any other sensor. In general, the sensor system 37 may be configured to capture data associated with the operation of one or more components of the vehicle 10 and/or data associated with the field 24 surrounding the vehicle 10. For instance, the sensor system 37 may include one or more sensors 108 that capture data related to the to-be-harvested crops C. In some cases, the data related to the harvested crop C can include a type of crop C to be harvested, a target 39 associated with the crops C, the location/position of the crops C, and/or any other information.

In various examples, a support 118 may be operably coupled with the frame 100 of the topper assembly 30. Alternatively, the support 118 may be integrally formed with the support 118, or any other component of the topper assembly 30. As illustrated, the support 118 can include a first portion 120 and a second portion 122 that is offset from the first portion 120. In some examples, the first sensor 110 can be operably coupled with the first portion 120, and the second sensor 112 operably coupled with the second portion 122. However, the first sensor 110 and the second sensor 112 may be operably coupled with a common portion of the support 118, any other component of the topper assembly 30, and/or any other component of the vehicle 10 without departing from the scope of the present disclosure.

In some examples, the first sensor 110 may have a first focal axis 124, which may correspond to a vehicle vertical direction, as generally illustrated by arrow 126 in FIG. 2. The second sensor 112 may have a second focal axis 128, which may be perpendicular to the first focal axis 124 and parallel to a vehicle fore-aft axis, as generally illustrated by arrow 130 in FIG. 2. In other examples, the first focal axis 124 and the second focal axis 128 may be parallel to one another or offset in any other manner without departing from the teachings provided herein. In some instances, the first sensor 110 may be configured to capture data indicative of a distance from a target 39 (e.g., an upper region or a tip of the leaves) of the crop C to the first sensor 110. Additionally or alternatively, the second may be configured to capture data indicative of a distance from the second sensor 112 to an oncoming obstacle (e.g., taller crops C). Additionally or alternatively, as shown in FIG. 2, the second sensor 112 may be installed on the cab 18 with a focal axis directed forwardly and/or laterally outward from the cab 18 to capture data forwardly of the cab. In several examples, each of the first sensor 110 and the second sensor 112 may be configured as vision-based or wave-based sensors, such as cameras/imagers, radar sensors, ultrasound sensors, LIDAR devices, etc.

Additionally or alternatively, the sensor system 37 can include one or more operational sensors 114 that are configured to capture operation-related data associated with the operating conditions of the topper assembly 30. The operating conditions may include an operational status of the pair of gathering disks 32 and/or a cutting disk 34, a height of the cutting disk 34, a tilt angle of the topper assembly 30 relative to the field 24 and/or the frame 12 of the vehicle 10, and/or any other operating condition. In some instances, the operational sensor 114 can be configured as a pressure sensor that may provide data indicative of a pressure with one or more of the motors, thereby indicating an operating condition of the gathering disk 32 and/or cutting disk 34 operably coupled with the motor.

Additionally or alternatively, the sensor system 37 can include an adjustment assembly sensor 116 that can be configured to monitor a position of the arms 36 and/or a component of the topper assembly 30.

The topper assembly 30, the adjustment assembly 35, and/or the sensor system 37 may be operably coupled with a computing system 202. The computing system 202 may further be configured to receive an input related to a defined offset. The defined offset may be a defined height of the upper portion Cᵤₚ of the to-be-harvested crop C that is to be severed from the remaining stalks Cₛ.

In operation, the computing system 202 can determine a first distance from the target 39 (e.g., a tip of the leaves) to the first sensor 110 based on data captured from the first sensor 110. Additionally or alternatively, the computing system 202 can determine a second distance from a forwardly located obstacle (e.g., taller plants). In turn, the computing system 202 may determine a cutting position of the cutting disk 34 to severe an upper portion Cᵤₚ of the crop C that is defined by a defined offset from the target 39 of the crop C. The computing system 202, based on the determined cutting position, may activate the adjustment assembly 35 to set a height of the cutting disk 34 at the cutting position. As the vehicle 10 moves through the field 24, the target 39 of subsequent to-be-harvested crops C is determined based on the data, which is then used to alter the position of the cutting disk 34, such as when the to be harvested crop C is varied from the previously harvested crop C.

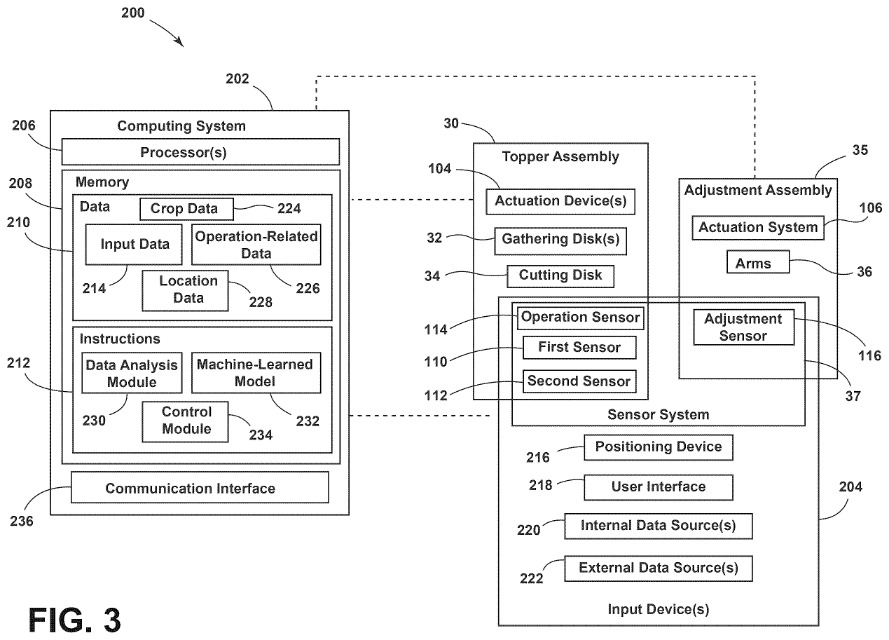

Referring now to FIG. 3, a schematic view of examples of a system 200 is illustrated in accordance with aspects of the present subject matter. In general, the system 200 will be described herein with reference to the vehicle 10 described above with reference to FIGS. 1 and 2. However, it will be appreciated that the disclosed system 200 may generally be utilized with vehicles having any suitable vehicle configuration.

In several examples, the system 200 may include a computing system 202 and various other components configured to be communicatively coupled to and/or controlled by the computing system 202, such as various input devices 204 and/or various components of the vehicle 10. In some examples, the computing system 202 can operate to determine a cutting position of the topper assembly 30 based at least partially on data captured by one or more sensors 108 and, further, to initiate one or more control actions associated with a vehicle 10, such as by altering a height of a topper assembly 30 based on the defined cutting position. In various instances, the computing system 202 is physically coupled to the vehicle 10. In other examples, the computing system 202 is not physically coupled to the vehicle 10 (e.g., the computing system 202 may be remotely located from the vehicle 10) and instead may communicate with the vehicle 10 over a wireless network.

In general, the computing system 202 may correspond to any suitable processor-based device(s), such as a computing device or any combination of computing devices. Thus, as shown in FIG. 3, the computing system 202 may generally include one or more processor(s) 206 and associated memory 208 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 208 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 208 may generally be configured to store information accessible to the processor(s) 206, including data 210 that can be retrieved, manipulated, created, and/or stored by the processor(s) 206 and instructions 212 that can be executed by the processor(s) 206.

In several examples, the data 210 may be stored in one or more databases. For example, the memory 208 may include an input database 214 for storing input data received from the one or more input devices 204. In some examples, the one or more input devices 204 may include the sensor system 37, one or more positioning device(s) 216 for generating position data associated with the location of the vehicle 10, one or more user interfaces 218 for allowing operator inputs to be provided to the computing system 202 (e.g., buttons, knobs, dials, levers, joysticks, touch screens, and/or the like), one or more other internal data sources 220 associated with the vehicle 10 (e.g., other devices, databases, etc.), one or more external data sources 222 (e.g., a remote computing device or server, including, for instance, a machine-learning computing system 202), and/or any other suitable one or more input devices. The data received from the one or more input devices 204 may, for example, be stored within the input database 214 for subsequent processing and/or analysis.

It will be appreciated that, in addition to being considered an one or more input devices 204 that allows an operator to provide inputs to the computing system 202, the user interface 218 may also function as an output device. For example, the user interface 218 may be configured to allow the computing system 202 to provide feedback to the operator (e.g., visual feedback via a display or other presentation device, audio feedback via a speaker or other audio output device, and/or the like).

As shown in FIG. 3, the memory 208 may also include a crop-related database 224 for storing information or data associated with to-be-harvested crops C and/or the field 24. For example, as indicated above, based on the data received from the one or more input devices 204, the computing system 202 may be configured to estimate or calculate a type of crop C to be harvested, a target 39 of the crop C, an object 41 proximate to the vehicle 10, and/or any other information. The target 39 of the crop C, which may be determined based on data from a first sensor 110, and the position of an object 41 proximate to the vehicle 10, which may be determined based on data from a second sensor 112, may be used by the computing system 202 to determine the location/position of the crops C. The location/position of the crops C may include a height of the crops C, a position of the crops C relative to one another, a location of the crops C relative to a field 24, a verticality of the crops C (e.g., whether crops are growing in a vertical duration and/or have fallen and are no longer in a generally vertical orientation). The data may then be stored within the crop-related database 224 for subsequent processing and/or analysis.

Additionally, as shown in FIG. 3, the memory 208 may include an operation-related database 226 for storing information or data associated with the harvest-related parameter(s) for the vehicle 10. For example, as indicated above, based on the input data received from the one or more input devices 204, the computing system 202 may be configured to estimate or calculate a position of the topper assembly 30 such that the cutting disk 34 is positioned at the cutting position, which may be a defined offset from the top of the to be harvested crop C. The topper assembly 30 position may then be stored within the operation-related database 226 for subsequent processing and/or analysis.

Moreover, in several examples, the memory 208 may also include a location database 228 storing location information about the vehicle 10 and/or information about the field 24 being processed (e.g., a field map). Such location database 228 may, for example, correspond to a separate database or may form part of the input database 214. As shown in FIG. 3, the computing system 202 may be communicatively coupled to the positioning device(s) 216 installed on or within the vehicle 10. For example, in some examples, the positioning device(s) 216 may be configured to determine the exact location of the vehicle 10 using a satellite navigation position system (e.g., a GPS, a Galileo positioning system, the Global Navigation satellite system (GLONASS), the BeiDou Satellite Navigation and Positioning system, and/or the like). In such an example, the location determined by the positioning device(s) 216 may be transmitted to the computing system 202 (e.g., in the form of coordinates) and subsequently stored within the location database 228 for subsequent processing and/or analysis.

Additionally, in several examples, the location data stored within the location database 228 may also be correlated to all or a portion of the input data stored within the input database 214. For instance, in some examples, the location coordinates derived from the positioning device(s) 216 and the data received from the input devices 204 may both be time-stamped. In such an example, the time-stamped data may allow the data received from the input devices 204 to be matched or correlated to a corresponding set of location coordinates received from the positioning device(s) 216, thereby allowing the precise location of the portion of the field 24 associated with the input data to be known (or at least capable of calculation) by the computing system 202.

Moreover, by matching the input data to a corresponding set of location coordinates, the computing system 202 may also be configured to generate or update a corresponding field map associated with the field 24 being processed. For example, in instances in which the computing system 202 already includes a field map stored within its memory 208 that includes location coordinates associated with various points across the field 24, the input data received from the input devices 204 may be mapped or correlated to a given location within the field map. Alternatively, based on the location data and the associated image data, the computing system 202 may be configured to generate a field map for the field 24 that includes the geo-located input data associated therewith.

Referring still to FIG. 3, in several examples, the instructions 212 stored within the memory 208 of the computing system 202 may be executed by the processor(s) 206 to implement a data analysis module 230. In general, the data analysis module 230 may be configured to analyze the data (e.g., a set of data received at a given time or within a given time period or a subset of the data, which may be determined through a pre-processing method) to determine the target 39 of the crop C using any algorithm. In some instances, the data analysis module 230 can cooperatively operate with or otherwise leverage a machine-learned model 232 to analyze the data 224 to determine the target 39 of the crop C. In some examples, a color-based algorithm may be utilized that relies on color differences to determine a target 39 (e.g., a maximum height) of the crop C and/or an object 41 proximate to the vehicle 10. In further examples, the model may include an algorithm that identifies the differences in the reflectivity or spectral absorption between the upper portion Cᵤₚ of the crop C and the stalks Cₛ contained within the data.

Additionally or alternatively, the data analysis module 230 may be configured to analyze the operation-related data (e.g., a set of operation-related data received at a given time or within a given time period or a subset of the operation-related data, which may be determined through a pre-processing method) to determine the position of the cutting disk 34 using any algorithm. In some instances, the data analysis module 230 can cooperatively operate with or otherwise leverage a machine-learned model 232 to analyze the operation-related data 226 to determine the position of the cutting disk 34.

Referring still to FIG. 3, the instructions 212 stored within the memory 208 of the computing system 202 may also be executed by the processor(s) 206 to implement a control module 234. The control module 234 may be configured to adjust the position of the cutting disk 34 when the position of the cutting disk 34 is varied from a cutting position by controlling one or more components of the adjustment assembly 35. In general, the cutting position is defined as a position along the crop C that is a defined offset below the target 39 of the crop C. Thus, the system 200 can detect a target 39 of the crop C and reactively adjust a position of the topper assembly 30 so that a generally common upper portion Cᵤₚ height is severed from the crop C.

Moreover, as shown in FIG. 3, the computing system 202 may also include a communications interface 236 to communicate with any of the various other system components described herein. For instance, one or more communicative links or interfaces (e.g., one or more data buses and/or wireless connections) may be provided between the communications interface 236 and the one or more input devices 204 to allow data transmitted from the one or more input devices 204 to be received by the computing system 202. Additionally, as shown in FIG. 3, one or more communicative links or interfaces (e.g., one or more data buses and/or wireless connections) may be provided between the communications interface 236 and one or more electronically controlled components of the vehicle 10 to allow the computing system 202 to control the operation of such system components.

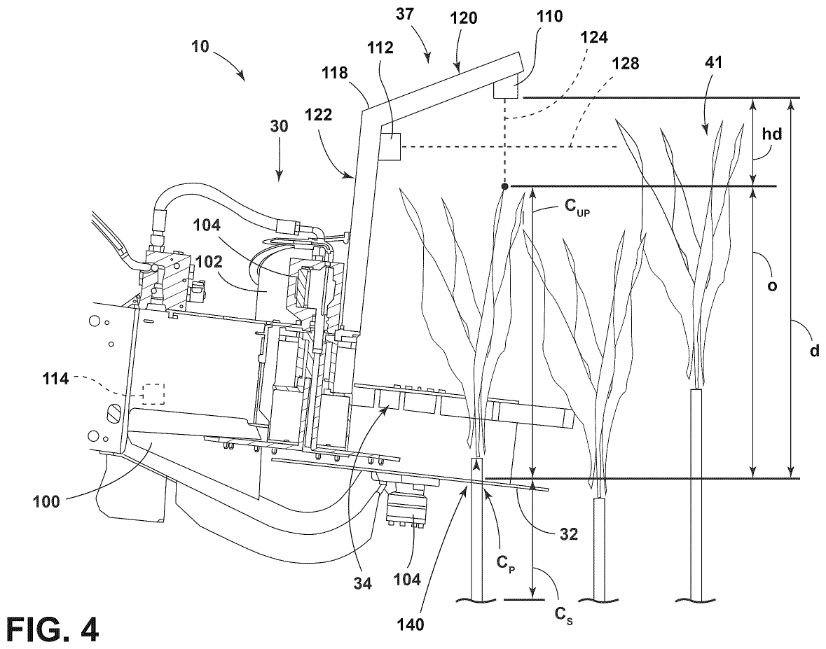

Referring now to FIGS. 3-7, in operation, as the vehicle 10 traverses a field 24, a first sensor 110 may be installed on the topper assembly 30 (and/or any other location of the vehicle 10) for capturing vision-based data of the to-be-harvested crop C (and/or previously harvested portions of the field 24). The first sensor 110 may be configured to capture vision-based data relative to a first focal axis 124 of the first sensor 110. In some cases, the first focal axis 124 may correspond to a vehicle vertical direction. In such instances, the first sensor 110 may be positioned vehicle forward of the cutting disk 34 and/or otherwise positioned relative to the cutting disk 34. The computing system 202 may determine the target 39 of the crop C below the first sensor 110 based at least partially on the data captured by the first sensor 110. Additionally or alternatively, the data can include a type of crop C to be harvested, a location/position of the crops C, and/or any other information.

In some instances, the first sensor 110 may be positioned at a fixed distance d from the cutting disk 34. Moreover, a defined offset O may be a defined height of the upper portion Cᵤₚ of the to-be-harvested crop C that is to be severed from the remaining stalks Cₛ. As such, a cutting height may be determined by the computing system 202 that is equal to a height difference hd between the fixed distance d from the cutting disk 34 to the first sensor 110 and the defined offset O. As such, in operation, the topper assembly 30 may be manipulated to maintain the first sensor 110 at a distance from the target 39 of the crop C that is equal to the height difference hd.

Additionally or alternatively, the second sensor 112 may be installed on the topper assembly 30 (and/or any other location of the vehicle 10) for capturing vision-based data of the to-be-harvested crop C (and/or previously harvested portions of the field 24). The second sensor 112 may be configured to capture vision-based data relative to a second focal axis 128 of the second sensor 112. In some cases, the second focal axis 128 may be perpendicular to or otherwise intersect the first focal axis 124. Additionally or alternatively, the second focal axis 128 may be parallel to a vehicle fore-aft axis. The computing system 202 may determine an object 41 proximate to the vehicle 10, such as crop C, forwardly of the vehicle 10 based at least partially on the data captured by the second sensor 112. Additionally or alternatively, the data can include a type of crop C to be harvested, a location/position of the crops C, and/or any other information.

In some examples, the second sensor 112 may have a second focal axis 128 that is offset from a horizontal axis 124 relative to the frame 12 of the vehicle 10 and/or parallel to a cutting axis 140 that extends vertically forward of the cutting position. In operation, the computing system 202 may be configured to estimate a height of the crop C based on the data from the second sensor 112 before the first sensor 110 is positioned above the detected crop C. As such, the data from the second sensor 112 may be used to determine an intermediate position of the cutting disk 34 and a subsequent cutting position may be determined based on the data from the first sensor 110.

In various examples, the second sensor 112 can capture data that may be used to generate a point cloud (or other representation of the captured data) of the canopy profile of the crop C. Based on the canopy profile, the adjustment assembly 35 may alter the position of the topper assembly 30. In turn, the computing system 202 can determine a final cutting position Cp based on data from the first sensor 110. In some examples, the second sensor 112 may also be configured to capture data related to crops C that will be harvested in an upcoming pass. In such instances, the data may be used to determine a canopy profile proactively so that one or more alterations of the topper assembly 30 may be preprogrammed prior to the crop C being the next to be harvested crop C. Additionally or alternatively, the canopy profile may be captured in conjunction with location data so that a canopy profile map may be created. The canopy profile map may be provided to one or more input devices 204 and/or other electronic devices to improve the productivity and yield of the field 24.

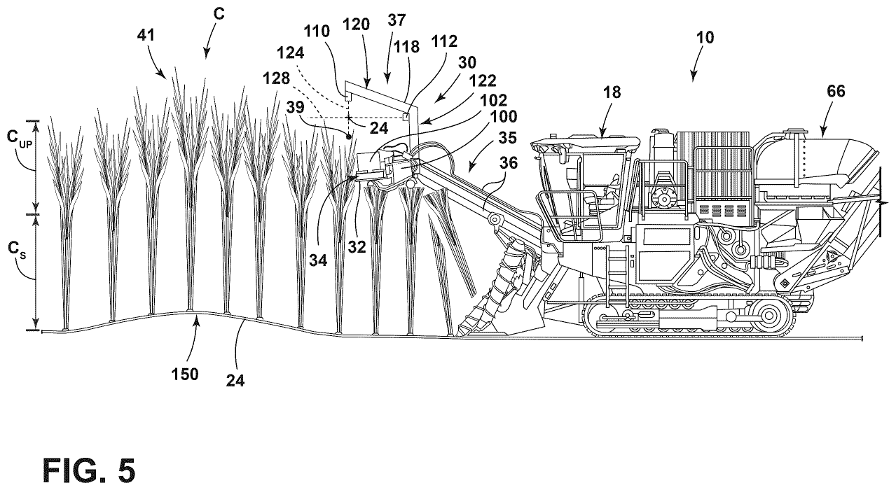

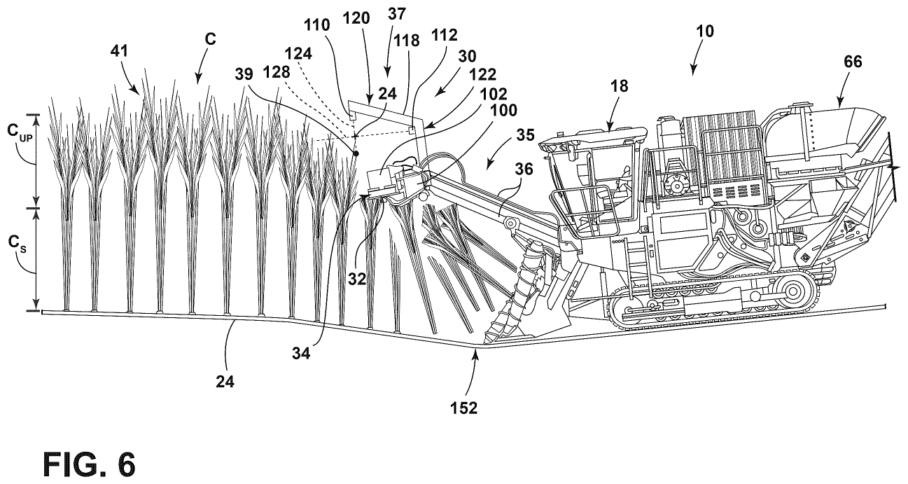

With further reference to FIGS. 3-7, through the use of the sensor system 37 including the first sensor 110 and the second sensor 112 described herein, the vehicle 10 may be configured to detect various field conditions and/or crop conditions and proactively adjust the topper assembly 30 to accommodate the field conditions and/or crop conditions. For example, as shown in FIG. 5, the field 24 may include height variations in the form of raised sections 150, and/or, as shown in FIG. 6, the field 24 may include height variations in the form of lowered sections 152. In either case, the height variations may cause the crop C, which may be of generally similar height, to have upper portions that are vertically offset from one another. As such, the position of the first sensor 110 may be vertically adjusted to maintain the first sensor 110 in a position that is above the crop C based on data captured from the second sensor 112 and/or any other sensor within the sensor system 37. In some instances, the second sensor 112 may capture vision-based data that is forward of the vision-based data of the first sensor 110. As such, the data from the second sensor 112 may be used to determine an intermediate position of the cutting disk 34 and a subsequent cutting position may be determined based on the data from the first sensor 110.

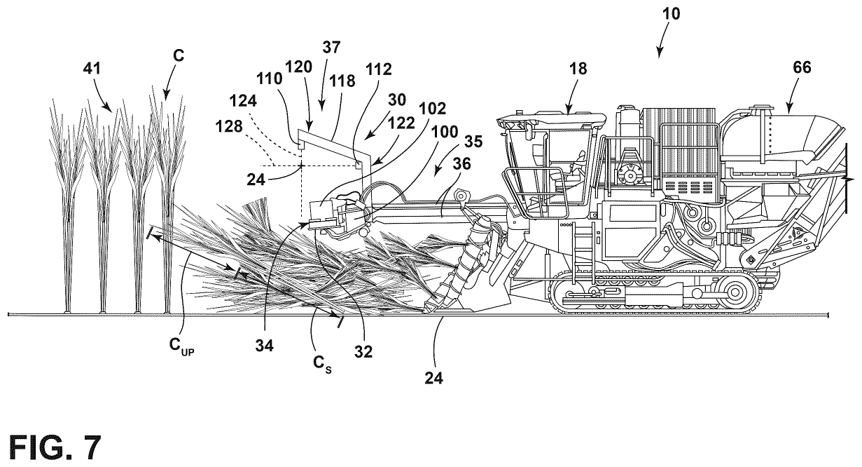

As shown in FIG. 7, the crop C may be in a fallen and/or otherwise non-vertical position. In such instances, the position of the first sensor 110 may be vertically lowered to maintain the first sensor 110 in a position that is above the crop C based on data captured from the second sensor 112 and/or any other sensor within the sensor system 37. In some cases, the lowering of the first sensor 110 before the first sensor 110 is vertically above the to be cut crop may allow for increased clarity of the second sensor 112 for increased detection of the target 39 of the crop C. As provided herein, the second sensor 112 may capture vision-based data that is forward of the vision-based data of the first sensor 110. As such, the data from the second sensor 112 may be used to determine an intermediate position of the cutting disk 34 and a subsequent cutting position may be determined based on the data from the first sensor 110.

Additionally or alternatively, the sensor system 37 may further be configured to detect a vehicle 10, such as a trailer, within the field 24. Moreover, once a vehicle is detected, the location of the vehicle relative to the vehicle 10 and/or type of vehicle may be established. Furthermore, when the vehicle is detected within a defined zone proximate to the vehicle 10 and is identified as a trailer that is capable of retaining harvested crop, the vehicle 10 may automatically and/or within operator intervention, begin directing the harvested crop C into the vehicle.

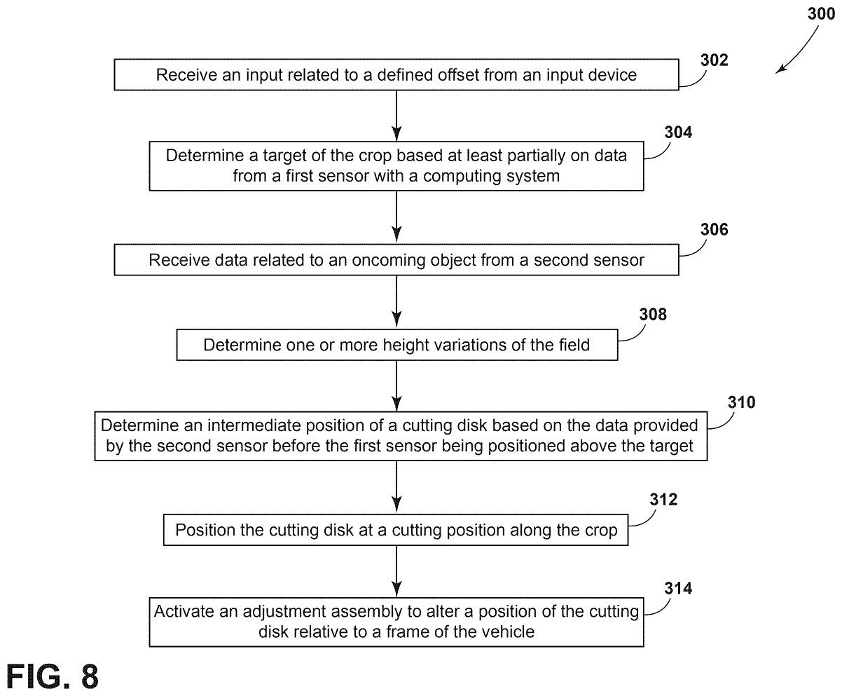

Referring now to FIG. 8, a flow diagram of a method 300 for operating an agricultural vehicle is illustrated in accordance with aspects of the present subject matter. In general, the method 300 will be described herein with reference to the agricultural vehicle 10 and related components described with reference to FIGS. 1-7. It will be appreciated, however, that the disclosed method 300 may be implemented with vehicles having any other suitable configurations and/or within systems having any other suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 8, at (302), the method 300 may include receiving, from an input device, an input related to a defined offset. The defined offset may be a defined height of the upper portion of the to-be-harvested crop that is to be severed from the remaining stalks.

At (304), the method 300 can include determining a target of the crop based at least partially on data from a first sensor with a computing system. At (306), the method can include receiving data related to an oncoming object from a second sensor. In various examples, a first focal axis of the first sensor is configured to align with a vehicle vertical direction, and a second focal axis of the second sensor is configured to intersect the first focal axis.

In some cases, the method 300, at (308), can further include determining one or more height variations of the field based on data from the first sensor or the second sensor.

At (310), the method 300 can include positioning a cutting disk at a cutting position along the crop. In some instances, the cutting position is the defined offset below the target. In some cases, positioning the cutting disk at the cutting position along the crop can further include, at (312), determining an intermediate position of the cutting disk based on the data provided by the second sensor before the first sensor is positioned above the target. In some examples, the cutting position is determined when a focal axis of the first sensor passes a target. Additionally or alternatively, the intermediate position is at least partially based on the detected one or more height variations positioning a cutting disk at a cutting position along the crop

At (314), the method 300 can include activating an adjustment assembly to alter a position of the cutting disk relative to a frame of the vehicle. As provided herein, the cutting disk is configured to sever an upper portion of the crop that is defined by a defined offset from the target of the crop. The severed crop may then be harvested by a harvesting system of the vehicle.

In various examples, the method 300 may implement machine learning methods and algorithms that utilize one or several machine learning techniques including, for example, decision tree learning, including, for example, random forest or conditional inference trees methods, neural networks, support vector vehicles, clustering, and Bayesian networks. These algorithms may include computer-executable code that may be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for an agricultural vehicle, the system comprising:
a topper assembly including a cutting disk configured to severe an upper portion of a crop;
a sensor system including a first sensor having a first focal axis and configured to capture data associated with the crop and a second sensor having a second focal axis and configured to capture data associated with the crop, the first focal axis offset from the second focal axis; and
a computing system including one or more processors and one or more non-transitory computer-readable media that collectively store instructions that, when executed by the one or more processors, configure the computing system to perform operations, the operations comprising:
receiving an input related to a defined offset;
detecting an object forward of the topper assembly based at least partially on the data from the second sensor;
determining a target of the crop based at least partially on the data from the second sensor; and
positioning the cutting disk at a cutting position along the crop, wherein the cutting position is the defined offset below the target.

2. The system of claim 1, wherein each of the first sensor and the second sensor is a vision-based sensor, and wherein the data is image data.

3. The system of claim 1, wherein the target is a maximum height of the crop.

4. The system of claim 1, wherein the first sensor is positioned at least partially vehicle forward of the cutting disk.

5. The system of claim 1, further comprising:
an input device configured to provide the defined offset to the computing system.

6. The system of claim 1, wherein the first sensor is positioned vehicle forward of the second sensor.

7. The system of claim 6, wherein the data captured by the second sensor is at least partially forward of the first sensor.

8. The system of claim 1, wherein the first focal axis is configured to align with a vehicle vertical direction and the second focal axis is configured to intersect the first focal axis.

9. The system of claim 1, further comprising:
an adjustment assembly configured to alter a position of the cutting disk relative to a frame of a vehicle.

10. A computer-implemented method for agricultural harvesting, the computer-implemented method comprising:
receiving, from an input device, an input related to a defined offset;
determining, with a computing system, a target of a crop based at least partially on data from a first sensor;
receiving, from a second sensor, data related to an object proximate to a vehicle; and
positioning a cutting disk at a cutting position along the crop, wherein the cutting position is the defined offset below the target.

11. The computer-implemented method of claim 10, wherein positioning of the cutting disk at the cutting position along the crop further comprises determining an intermediate position of the cutting disk based on the data provided by the second sensor before the first sensor being positioned above the target.

12. The computer-implemented method of claim 11, wherein the cutting position is determined when a focal axis of the first sensor passes the target.

13. The computer-implemented method of claim 11, further comprising:
determining, with the computing system, one or more height variations of a field, wherein the intermediate position is at least partially based on the one or more height variations.

14. The computer-implemented method of claim 10, wherein a first focal axis of the first sensor is configured to align with a vehicle vertical direction, and a second focal axis of the second sensor is configured to intersect the first focal axis.

15. The computer-implemented method of claim 14, wherein positioning the cutting disk at the cutting position along the crop further comprises activating an adjustment assembly to alter a position of the cutting disk relative to a frame of the vehicle.

16. A system for an agricultural vehicle, the system comprising:
a topper assembly including a cutting disk configured to severe an upper portion of a crop;
a sensor system including a first sensor having a first focal axis and a second sensor having a second focal axis, the second focal axis intersecting the first focal axis; and
a computing system including one or more processors and one or more non-transitory computer-readable media that collectively store instructions that, when executed by the one or more processors, configure the computing system to:
receive an input related to a defined offset;
receive data from the sensor system;
determine an intermediate position of the cutting disk based on data from the second sensor;
determine a target on the crop based on data from the first sensor; and
position the cutting disk at a cutting position along the crop based on data from the first sensor, wherein the cutting position is the defined offset below the target.

17. The system of claim 16, where the computing system is further configured to:
generate a canopy map based on a maximum height of the crop.

18. The system of claim 17, wherein the computing system is further configured to:
determine one or more height variations of a field, wherein the intermediate position is at least partially based on the one or more height variations.

19. The system of claim 16, wherein each of the first sensor and the second sensor is a vision-based sensor.

20. The system of claim 16, further comprising:
an adjustment assembly configured to alter a position of the cutting disk relative to a frame of a vehicle.
